(19) United States
(12) Patent Application Publication
(10) Pub. No.: US 2005/0135982 A1
(43) Pub. Date: Jun. 23, 2005

(54) Reduction of NOx using carbon nanotube and carbon fiber supported catalyst

(75) Inventor: Igor Pavlovsky, Austin, TX (US)

Correspondence Address: Kelly K. Kordzik;Winstead Sechrest & Minick P.C., P.O. Box 50784, Dallas, TX, 75201, US

(73) Assignee: Nano-Proprietary, Inc., Austin, TX (US)

(21) Appl. No.: 11/011,423

(22) Filed: Dec. 14, 2004

Related U.S. Application Data
(60) Provisional application No. 60/530,585, filed on Dec. 18, 2003.

(51) Int. Cl. B01J 21/18; B01J 23/00

(52) U.S. Cl. 423/239.1; 502/182; 502/185

(57) ABSTRACT

The present invention is directed to assemblies of catalyst material on support material that function to reduce NOₓ to N₂ and O₂ at appropriate temperatures. The present invention is also directed to the manufacture and use of such assemblies. Such assemblies improve upon the prior art in that they utilize metal nanoparticles on nanostructured carbon fiber supports. The use of such nanoscale components affords greater catalytic activity per catalyst amount by virtue of the much greater surface area of both the catalyst and the support.

### CROSS-REFERENCE TO RELATED APPLICATIONS

This Application claims priority to commonly-assigned U.S. Provisional Patent Application Ser. No. 60/530,585, filed Dec. 18, 2003.

### TECHNICAL FIELD

The present invention related generally to NOₓ reduction, and specifically to compositions for catalytically reducing NOₓ in combustion processes.

### BACKGROUND

NOₓ comprises approximately 90% NO and 10% NO₂. NOₓ is a toxic mixture typically produced in combustion processes in which nitrogen is present and becomes oxidized. Solar irradiation of NO₂ produces oxygen radicals which, in turn, react with molecular oxygen to form ground level or low-lying ozone (O₃), particularly during daylight hours. While O₃ in the upper atmosphere is beneficial for filtering harmful ultraviolet radiation, low-lying ozone is a pollutant and high levels of such low-lying ozone are a common concern, particularly for asthmatics.

Efforts to reduce NOₓ emission, particularly from automobiles, typically involve a catalytic reduction of NOₓ to N₂ and O₂. Generally, such reductions involve a noble metal (gold, silver, platinum, palladium, iridium, rhenium, rhodium, mercury, ruthenium, and osmium) catalyst. Current technologies, such as catalytic converters, include porous ceramic honeycomb structures or pellets (small ceramic beads) coated with noble metals, usually rhodium or rhodium alloys. The disadvantage of this is the high cost of these catalytic converters, their limited surface area, possible damage due to thermal shock, overheating meltdown, and poisoning by sulfur and silicon. Additionally, pelletized converters tend to build up considerable backpressure in the exhaust line, thus lowering the power of the engine or plant it is being used with.

As a result of the foregoing, there is a recognized need in having a more efficient and lower cost catalytic converter for NOₓ reduction to molecular nitrogen and oxygen in exhaust gas flow from cars, power plants, etc. This has led to two dissimilar concepts using carbon fibers for NOₓ reduction. The first is based on selective catalytic reactions taking place directly on the carbon fiber surface (e.g., PCT Pub. No. WO 97/01388). This first approach involves high temperatures (over 600° C.) and is not suitable for a number of applications requiring low working temperatures. The second concept is based on using carbon fibers as a support for metal oxide-based catalysts, wherein metal oxide particles dispersed in carbon fibers enable the decomposition of NOₓ at much lower temperatures (M. Yoshikawa, A. Yasutake, I. Mochida, Applied Catalysis A., vol. 173, no. 2, p. 239, 1998).

### SUMMARY OF THE INVENTION

Some embodiments of the present invention are directed to assemblies of catalyst material on a support material that function to reduce NOₓ to N₂ and O₂ at an appropriate temperature. Some embodiments of the present invention are also directed to the manufacture and use of such assemblies. Such assemblies improve upon the prior art in that they utilize metal nanoparticles on nanostructured carbon fiber supports. The use of such nanoscale components affords greater catalytic activity per catalyst amount by virtue of the much greater surface area of both the catalyst and the support.

The metal nanoparticles of the present invention are typically noble metals or alloys thereof, but could generally be any metal capable of reducing NOₓ to N₂ and O₂. Such nanoparticles typically have diameters below about 100 nm.

Nanostructured carbon fiber generally includes any carbon fiber material that is nanoscale (i.e., less than 100 nm) in at least one dimension. Exemplary forms of such nanostructured carbon fibers include vapor-grown carbon fibers, carbon nanotubes, carbon nanoscrolls, and combinations thereof.

Methods of making the assemblies of the present invention generally comprise a step of depositing metal nanoparticles on nanostructured carbon fibers serving as supports. Such depositing typically involves a depositing technique such as electroless deposition, electrochemical deposition, calcination, and/or mechanical incorporation.

Methods of using the assemblies of the present invention generally involve the incorporation of such assemblies into combustion processes or devices such that combustion products (in the form of flue gas or exhaust) are passed over or through the assembly to reduce NOₓ to N₂ and O_{2.}

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a plot depicting percentage of atoms at the surface of a Rh particle as a function of the particle size;

FIG. 2 is an SEM image showing rhodium nanoparticles on a MWNT support, the nanoparticles deposited by an electroless deposition method in accordance with some embodiments of the present invention;

FIGS. 3A and 3B illustrate two catalytic system designs using a carbon nanotube-supported catalyst assembly in accordance with some embodiments of the present invention, where FIG. 3B differs from FIG. 3A in that it has channels for improved gas flow; and

FIG. 4 is a plot of NO reduction versus temperature when the NO is passed over catalyst (Rh)-coated MWNT pellets placed in a quartz tube, where the space velocity is 3600 h⁻¹, and the gas flow rates in the analyte mixture are 500, 100, and 0.25 sccm for N₂, O₂ and NO respectively.

### DETAILED DESCRIPTION OF THE INVENTION

In the following description, specific details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

The present invention is directed to assemblies of catalyst material on a support material that function to reduce NOₓ to N₂ and O₂ at an appropriate temperature. The present invention is also directed to the manufacture and use of such assemblies. Generally, such assemblies utilize metal nanoparticles deposited on nanostructured carbon fiber supports. The use of such nanoscale components affords greater catalytic activity per catalyst amount by virtue of the much greater surface area of both the catalyst and the support.

The present invention exploits the nanoscale properties of metal nanocatalysts and nanostructured carbon fibers to solve many of the current problems of catalytic converters. For example, nanostructured carbon fibers can make such a converter with low backpressure in the exhaust line. Furthermore, the nanostructured carbon fiber material is a cost-effective approach to making high surface area catalytic converters, as the converters made from such materials are easier to manufacture, since no machining, casting, or special treatment of the material is generally necessary.

The metal nanoparticles of the present invention are typically noble metals or alloys thereof, but could generally be any metal capable of reducing NOₓ to N₂ and O₂. Such nanoparticles typically have diameters below about 100 nm. Noble metals are generally considered to include gold (Au), silver (Ag), platinum (Pt), palladium (Pd), iridium (Ir), rhenium (Re), rhodium (Rh), mercury (Hg), ruthenium (Ru), and osmium (Os). In some embodiments, the alloying of catalytic metals may serve to decrease the temperature at which reduction occurs. Moreover, by making the catalytic particles nanometer-sized rather then micron-sized, the amount of catalyst required is significantly decreased—which is an important cost consideration when noble metals are used. Additionally or alternatively, non-noble metals and/or metal oxides could be used.

Although nanocatalysts are not yet a widely discussed topic in science, some publications on the advantages of using nanocatalysts are starting to appear in the literature (see, e.g., Argo et al., Nature, vol. 415, p. 623, 2002). Thus, in some embodiments, the dimensional nature of the nanocatalysts (nanoparticulate metal) may itself serve to increase the rates of catalytic reactions.

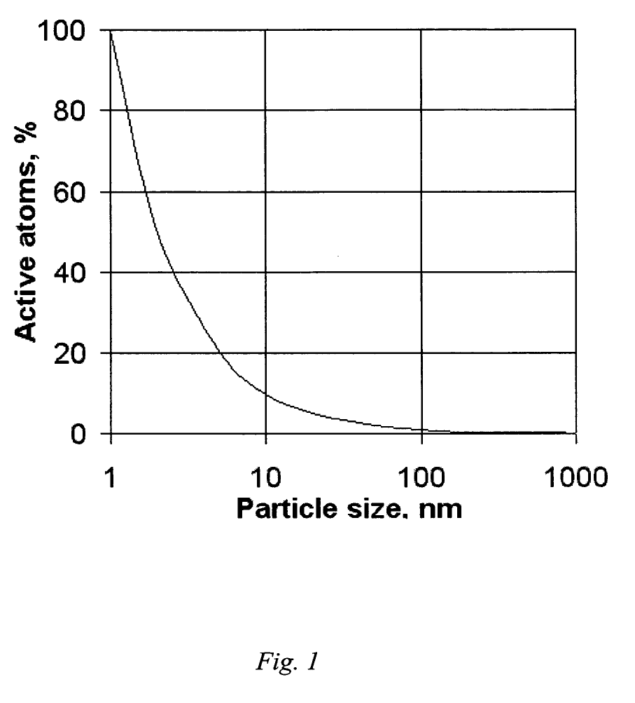

It is the surface of the catalyst that promotes the catalytic process; the bulk part of the catalyst particles plays only a minor role in the reaction process. The fraction of atoms comprising a particle's surface is approximately inversely proportional to the particle size. For example, for rhodium metal with a 0.38 nm lattice constant, almost all Rh atoms will be on the surface of a 1 nm particle. With increasing particle size, a smaller percentage of atoms will take part in the reaction; i.e., only 10% of the Rh in 10 nm sized particles will participate in catalysis. For particles adhering to a support surface, this percentage will be even less. To better illustrate this surface to size relationship, FIG. 1 is a plot depicting the percentage of atoms at the surface of a Rh particle as a function of the particle size.

The nanocatalyst approach described herein solves catalytic converter design issues as well, such as matching the size of the catalyst nanoparticles to the carbon nanofiber diameter and promoting stronger adhesion between the metal catalyst particles and the support.

Nanostructured carbon fiber, according to the present invention, generally includes any carbon fiber material that is nanoscale (i.e., less than 100 nm) in at least one dimension. Exemplary forms of such nanostructured carbon fibers include vapor-grown carbon fibers, carbon nanotubes, carbon nanoflakes, carbon nanoscrolls, and combinations thereof. Due to the nanometer-scale diameters and microns lengths of nanostructured carbon fibers, the effective surface area is very high and can reach 106 cm²/g for 10 nm radius carbon nanotubes. The nanotube surface area is inversely proportional to the average nanotube diameter for the same mass sample. Higher surface area contributes to higher conversion efficiency of the catalytic converter. Furthermore, the nanostructured carbon fibers are flexible in the bulk form, and are not subject to breaking or cracking.

In some cases, cost considerations may favor the use of nanoscale carbon fibers over carbon nanotubes. From a chemical point of view, these materials are similar in their graphitic nature. Generally, carbon nanotubes are thinner than carbon fibers. Typically, single-wall nanotubes (SWNT) have diameters of about 1-2 nm, multi-wall nanotubes (MWNT) are generally between about 2 and 200 nm, and vapor-grown carbon fibers (VGCF) are generally 60 nm and thicker. At the same time, the price of these materials is very different: MWNTs are typically 1-2 orders of magnitude more expensive than VGCFs, and SWNTs are typically an order of magnitude more expensive than MWNTs.

Methods of making the assemblies of the present invention generally comprise a step of depositing metal nanoparticles on nanostructured carbon fibers serving as supports. Such depositing typically involves a depositing technique such as electroless deposition, electrochemical deposition, calcination, and/or mechanical incorporation. The resulting assembly generally has a nanoparticle metal concentration between about 0.1 weight percent and about 50 weight percent.

In some embodiments, the nanostructured carbon fibers must first be purified prior to being used as a support. This can be particularly important where transition metal catalysts (e.g., Fe, Co, or Ni) have been used in the fabrication of such materials.

An exemplary assembly comprises rhodium nanoparticles on a MWNT support, whereby the Rh nanoparticles have been deposited by an electroless deposition technique. The catalytic reactions that take place for decomposition of NOₓ over such an exemplary catalyst system are:
2NO→N₂ +O₂, and
2NO₂→N₂+2O₂, (T=350-450° C.).

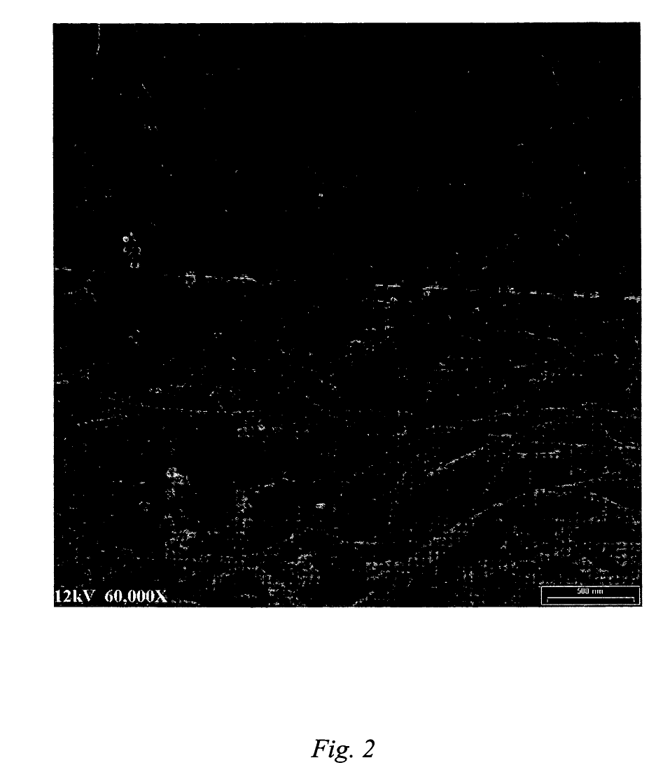

FIG. 2 is a scanning electron microscopy (SEM) image showing MWNTs coated with rhodium catalyst by an electroless deposition method, in accordance with the aforementioned exemplary assembly of the present invention, where the nanoparticles of Rh have diameters that are on the order of the MWNT diameters.

Methods of using the assemblies of the present invention generally involve the incorporation of such assemblies into combustion processes and/or systems such that the combustion products (in the form of flue gas or exhaust) are passed over or through the assembly and reduce NOₓ to N₂ and O₂. In some embodiments, the assembly is heated to accelerate such reduction. The choice of the deposition technique may affect the efficiency of catalytic reduction.

The carbon nanotube-based catalytic systems for NOₓ reduction are expected to work at temperatures as low as 200-300° C.—similar to silica-based catalytic systems. Alloying rhodium with other metals can likely further lower the operation temperature of the carbon nanotube-based catalysts.

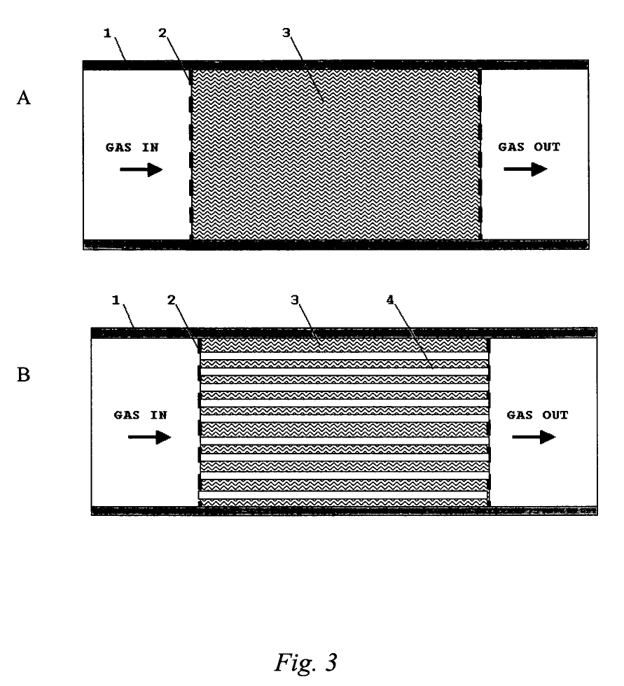

Referring to FIGS. 3A and 3B, in some embodiments, the assemblies can be integrated with a catalytic system (catalytic converter). Such systems may comprise a carbon nanotube-supported catalyst and may have the design shown in FIG. 3A, where the converter body 1 includes gas permeable ceramic disks 2 that hold the carbon nanotube-based catalyst 3 (in the form of pellets that are approximately 1-2 mm in diameter) within a certain volume. In another embodiment, shown in FIG. 3B, to improve the gas flow and reduce the gas backpressure, channels 4 can be made in a CNT-based catalyst 3 so that the gas will turbulently flow along the channels 4 and react with the CNT-supported catalyst 3. Other channel configurations may be incorporated as well.

The following examples are provided to demonstrate particular embodiments of the present invention. It should be appreciated by those of skill in the art that the methods disclosed in the examples which follow merely represent exemplary embodiments of the present invention. However, those of skill in the art should, in light of the present disclosure, appreciate that many changes can be made in the specific embodiments described and still obtain a like or similar result without departing from the spirit and scope of the present invention.

### EXAMPLE 1

This example illustrates the use of an assembly of the present invention for reducing NOₓ.

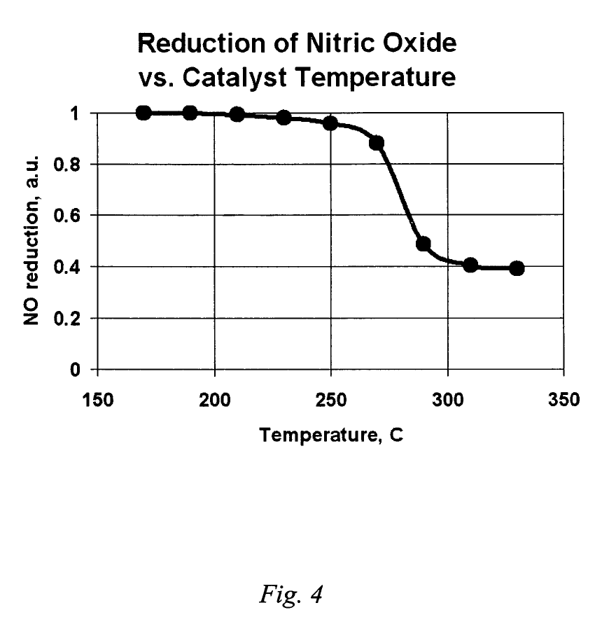

The catalytic performance test of the rhodium catalyst-coated MWNT pellets placed in a quartz tube was studied as a function of temperature at a given gas flow rate. The space velocity was 3600 h⁻¹, gas flow rates in the sample mixture were 500, 100, and 0.25 standard cubic centimeters per minute (sccm) of N₂, O₂, and NO respectively. The result of the test is shown in FIG. 4. The light-off temperature, defined as the temperature at which catalytic conversion reaches 50%, obtained was around 280° C., and is consistent with expectations for a pure rhodium catalyst. The effect saturates at 300° C. The reduction rate depends on the space velocity, as well as the design of the converter.

### EXAMPLE 2

This example illustrates how the technique of electroless deposition of metal can be used to deposit metal nanoparticles on a nanostructured carbon fiber support material.

A suspension of carbon fibers is prepared to which is added a suitable metal (e.g., rhodium) salt. While dispersed in this suspension, the rhodium salt is reduced by a reducing agent. Suitable rhodium salts include, but are not limited to, rhodium nitrate, rhodium chloride, and Na₂RhCl₆. Suitable reducing agents include, but are not limited to, hydrazine, sodium borohydride, and hydrazine+KOH+NH₄OH. Careful control of the concentrations ensures that the reduced metal precipitates as nanoparticles that are interspersed with the nanostructured carbon fibers when the solvent is removed.

### EXAMPLE 3

This example illustrates how the technique of electrochemical deposition (electroplating) of metal can be used to deposit metal nanoparticles on a nanostructured carbon fiber support material.

Using nanostructured carbon fibers as the anode of an electrochemical cell, rhodium metal can be deposited on the carbon fibers from a rhodium salt/acid bath when an appropriate potential is applied. The rhodium is electrochemically reduced at the surface of the anode and careful control of the concentrations ensures that the reduced metal precipitates as nanoparticles that are interspersed with the nanostructured carbon fibers when the carbon fibers are removed from the acid bath.

To further illustrate how Rh metal deposition quantities can be varied, Table 1 shows the variability (in grams) of Rh electrochemically produced for a series of conditions (compounds 1-7). Such conditions can be varied in the Rh nanoparticle deposition on a nanostructured carbon fiber material to optimize the resulting assembly for use in NOₓ reduction.

TABLE 1

| Compound | 1 | 2 | 4 | 5 | 6 | 7 |
|---|---|---|---|---|---|---|
| Rh₂(SO₄)₃.4H₂O | 2 g/L | 1.5-2 g/L | 5-10 g/l | 5-20 g/L | 2-2.5 g/l | 2 g/L |
| H₃PO₄(85%) | 40 ml/L | | | | | |
| H₂SO₄ | | 25-80 ml/L | 25-50 ml/L | 100 ml/L | 15 ml/L | |
| H₂SeO₄ | | | | 0.5-1 g/L | | |
| CuSO₄.5H₂O | | | | | 0.6 g/L | 0.3 g/L |
| MgSO₄ | | | | | 10-15 g/L | |
| Pb(NO₃)₂ | | | | | 5 mg/L | |
| NH₂SO₃H | | | | | | 20 g/L |
| Temperature (° C.) | 40-50 | 40-50 | 43-49 | 50 | 20-25 | 40-45 |
| Cathode | Pt | Pt | Pt | Pt | Pt | Pt |
| Amount of Rh, g | 0.73 | 0.55-0.73 | 1.8-3.6 | 1.8-7.3 | 0.73-0.91 | 0.73 |

### EXAMPLE 4

This example illustrates how the technique of calcination can be used to deposit metal nanoparticles on a nanostructured carbon fiber support material.

A rhodium salt (e.g., RhCl₃) aqueous solution is prepared to which carbon nanotubes (e.g., MWNT) are added and the solution is refluxed for 4 hours at 90° C. The solvent is then removed and the carbon nanotubes, in which the rhodium salt is interspersed, are dried in air for 2 hours. The rhodium salt is then reduced in a flow of H₂ at 550° C. to convert the salt to a metal. The product (assembly) is then typically subjected to a cleaning in 48% HF for 24 hours and is finally rinsed in deionized (DI) water and dried.

### EXAMPLE 5

This example illustrates how the technique of mechanical incorporation can be used to deposit metal nanoparticles on a nanostructured carbon fiber support material.

This technique uses mechanical treatment of nanostructured carbon fiber material in a mixture with catalytic nanoparticles in such a way that the particles adhere strongly to the carbon nanotubes or fibers. Such mechanical treatment can involve milling and/or grinding of the nanostructured carbon fiber material with metal or metal salts/oxides, the latter of which can be reduced in a subsequent step. This is a common technique that can be utilized for the purpose of making the material disclosed herein.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

1. An assembly comprising:
a) a nanostructured carbon fiber support material; and
b) a metal catalyst dispersed throughout the support material, wherein the metal catalyst is in the form of nanoparticles, and wherein the metal catalyst is capable of reducing NOₓ to N₂ and O₂.

2. The assembly of claim 1, wherein the nanostructured carbon fiber support material comprises carbon fibers selected from the group consisting of vapor-grown carbon fibers, carbon nanotubes, carbon nanoflakes, carbon nanoscrolls, and combinations thereof.

3. The assembly of claim 1, wherein the nanostructured carbon fiber support material comprises carbon nanotubes.

4. The assembly of claim 1, wherein the nanoparticles of metal catalyst comprise a noble metal.

5. The assembly of claim 4, wherein the noble metal is rhodium.

6. The assembly of claim 1, wherein the nanoparticles of metal catalyst comprise a mixture of noble metals.

7. The assembly of claim 6, wherein the noble metals are alloyed.

8. The assembly of claim 1, wherein the metal catalyst is present in the assembly in an amount between about 0.1 weight percent and about 50 weight percent.

9. A method comprising the deposition of metal nanoparticles on a nanostructured carbon fiber support material to form an assembly, wherein the metal nanoparticles are suitable for catalyzing the reduction of NOₓ.

10. The method of claim 9, wherein the nanostructured carbon fiber support material comprises carbon fibers selected from the group consisting of vapor-grown carbon fibers, carbon nanotubes, carbon nanoflakes, carbon nanoscrolls, and combinations thereof.

11. The method of claim 9, wherein the nanostructured carbon fiber support material has been purified.

12. The method of claim 9, wherein the deposition involves a depositing technique selected from the group consisting of electroless deposition, electrochemical deposition, calcination, mechanical incorporation, and combinations thereof.

13. The method of claim 9, wherein the metal nanoparticles of metal catalyst comprise a noble metal.

14. The method of claim 9, wherein the metal nanoparticles of metal catalyst comprise rhodium.

15. The method of claim 9, wherein the metal nanoparticles are deposited in an amount that results in a presence of such nanoparticles in the assembly between about 0.1 weight percent and about 50 weight percent.

16. A method comprising passing combustion effluent over an assembly, wherein the combustion effluent comprises NOₓ, and wherein the assembly comprises:
a) a nanostructured carbon fiber support material; and
b) a metal catalyst dispersed throughout the support material, wherein the metal catalyst is in the form of nanoparticles, and wherein the metal catalyst is capable of reducing NOₓ to N₂ and O₂.

17. The method of claim 16, wherein the nanostructured carbon fiber support material comprises carbon fibers selected from the group consisting of vapor-grown carbon fibers, carbon nanotubes, carbon nanoflakes, carbon nanoscrolls, and combinations thereof.

18. The method of claim 16, wherein the metal nanoparticles of metal catalyst comprise a noble metal.

19. The method of claim 16, wherein the metal catalyst is present in the assembly in an amount between about 0.1 weight percent and about 50 weight percent.

20. The method of claim 16, wherein the assembly is heated to facilitate the reduction of NOₓ.
